(19) United States
(12) Patent Application Publication
(10) Pub. No.: US 2026/0112517 A1
(43) Pub. Date: Apr. 23, 2026

(54) COLLIMATOR FOR RADIOGRAPHIC SYSTEMS

(71) Applicant: Team Industrial Services, Inc., Sugar Land, TX (US)

(72) Inventor: Charles Mark PIEFER, Alvin, TX (US)

(21) Appl. No.: 18/923,331

(22) Filed: Oct. 22, 2024

(51) Int. Cl. G21K 1/02

(52) U.S. Cl. CPC G21K 1/02

(57) ABSTRACT

A collimator comprising an outer surface, a radiation source bore, and a radiation port. The outer surface includes a first outer surface portion and a second outer surface portion. The second outer surface portion has a concave surface. The radiation port extending from an outer wall of the radiation source bore to the second outer surface portion.

### BACKGROUND

### Field

Embodiments of the invention generally relate to a collimator for use in radiographic systems.

### Description of the Related Art

Industrial radiographic systems are used to analyze material properties and internal structures of work pieces, for instance, by using radiation to image internal structures of the work pieces to determine weld integrity and material properties. In operation, a radiation source generates radiation that is directed at the structure to be tested. The radiation is used to image the internal structures of the work piece being tested. The images are used to analyze the internal structures of the work piece, such as, to analyze the material properties of the work piece. However, the radiation only needs to be directed towards the structure to be tested. This is achieved by a small port/window in the collimator. For safety purposes, the rest of the collimator is used to shield the work area and to obtain lower and safer limits during testing. This, in turn, reduces the size of the restricted area and lowers occupational doses. Collimators are used to shield the radiation. While there are many different types of collimators, there is a continuous need for new and/or improved collimators for use in industrial radiography.

### SUMMARY

In one or more embodiments, a collimator comprises an outer surface, a radiation source bore, and a radiation port. The outer surface includes a first outer surface portion and a second outer surface portion. The second outer surface portion has a concave surface. The radiation port extending from an outer wall of the radiation source bore to the second outer surface portion.

In one or more embodiments, a radiographic system comprises an exposure device, a controller having a cable that extends into the exposure device, a radiation source located in the exposure device and coupled to one end of the cable, and a collimator coupled to the exposure device. The controller extends and retracts the cable to move the radiation source between the exposure device and the collimator. The collimator includes an outer surface, a radiation source bore including an outer wall, and a radiation port. The outer surface includes a first outer surface portion including a first radius of curvature and a second outer surface portion including a second radius of curvature. The first radius of curvature is different from the second radius of curvature. The radiation port extends from the second outer surface portion to the outer wall of the radiation source bore.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1A illustrates a radiographic system in an undeployed state and positioned next to a work piece, according to one or more embodiments.

FIG. 1B illustrates the radiographic system of FIG. 1A in a deployed state and imaging the work piece, according to one or more embodiments.

FIG. 2 illustrates an isometric view of a collimator of the radiographic system of FIGS. 1A-1B, according to one or more embodiments.

FIG. 3 illustrates a rear view of the collimator of FIG. 2, according to one or more embodiments.

FIG. 4 illustrates a side cross-sectional view of the collimator of FIG. 2, according to one or more embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The disclosure contemplates that terms such as “couples,” “coupling,” “couple,” and “coupled” may include but are not limited to welding, interference fitting, and/or fastening such as by using bolts, threaded connections, pins, clips, and/or screws. The disclosure contemplates that terms such as “couples,” “coupling,” “couple,” and “coupled” may include but are not limited to integrally forming. The disclosure contemplates that terms such as “couples,” “coupling,” “couple,” and “coupled” may include but are not limited to direct coupling and/or indirect coupling, such as indirect coupling through components such as links.

Embodiments of the invention include systems, apparatus, and methods for using a collimator in a radiographic system to image work pieces with radiation (e.g. one or more gamma rays).

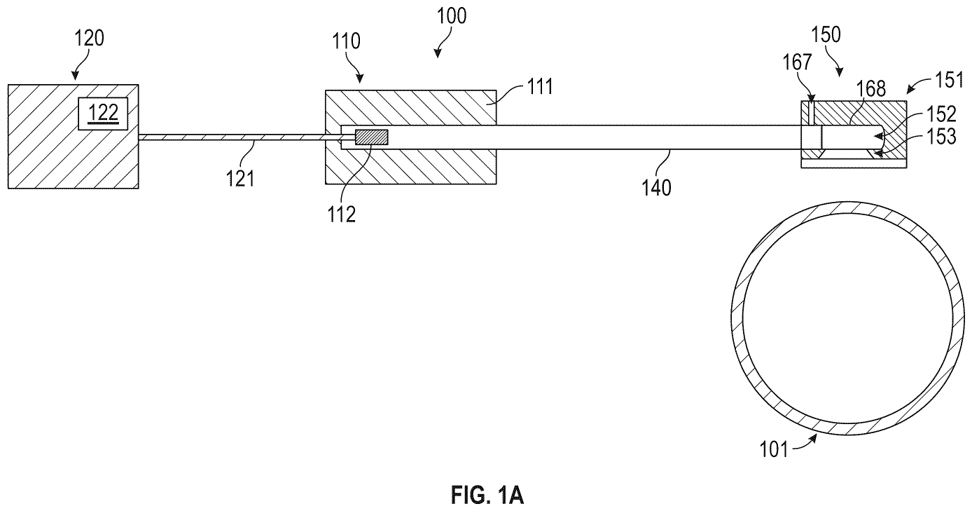

FIGS. 1A-1B illustrate a radiographic system 100 for use in imaging a work piece 101. FIG. 1A illustrates the radiographic system 100 in an undeployed state. When in the undeployed state, the radiographic system 100 is not being used to image a work piece, such as work piece 101. FIG. 1B illustrates the radiographic system 100 in the deployed state. When in the deployed state, the radiographic system 100 is being used to image a work piece, such as work piece 101. In one or more embodiments, the work piece 101 is a pipe or other type of tubular. In one or more embodiments, the work piece 101 is still assembled to its surrounding system. In one or more embodiments, the work piece 101 is disassembled from its surrounding system. In one or more embodiments, the surrounding system is a pipeline and the work piece 101 is one of the pipes that form the pipeline or is a portion of one of the pipes that form the pipeline.

The radiographic system 100 includes an exposure device 110, a controller 120, and a collimator 150. In one or more embodiments, the radiographic system includes a guide tube 140 disposed between the exposure device 110 and the collimator 150.

The exposure device 110 includes a housing 111 and a radiation source 112. The exposure device 110 contains the radiation source 112 that is used for imaging work pieces, such as the work piece 101, when the radiographic system 100 is in the undeployed state (e.g. when the radiographic system 100 is not being used to measure the work piece) as shown in FIG. 1A.

The housing 111 includes shielding. In one or more embodiments, the shielding is a casting made of depleted uranium (“DU”) shielding (e.g. U-238) inside of the housing 111. In one or more embodiments, the DU shielding shields the radiation source 112 from the environment to minimize the amount radiation outside of the exposure device 110 when the radiation source 112 is in the undeployed state.

The radiation source 112 includes a radioactive material which may be in the form of tiny wafers or pellets. The radioactive material may be a single solid piece (e.g. a wafer or a pellet) that is sealed in a double encapsulation to prevent leakage and contamination. The radiation source 112 emits radiation 102 (such as electromagnetic radiation) in the form of one or more gamma rays. When the radiation source 112 is in the undeployed state, the radiation source 112 located in the housing 111 and is shielded from the environment to prevent radiation 102 from emitting outside of the housing. In the deployed state, as shown in FIG. 1B, the radiation source 112 is located in the collimator 150 and is aligned with a radiation port 153 such that a cone of radiation 104 is emitted towards the work piece 101 to image the internal structure of various portions of the work piece 101.

The controller 120 includes a cable 121 that extends into the housing 111 and is coupled to the radiation source 112 at one end. The controller 120 is used to move the radiographic system 100 between the undeployed state, as shown in FIG. 1A, and the deployed state, as shown in FIG. 1B.

The controller 120 includes controls 122 that may be used to extend and retract the cable 121. In one or more embodiments, the controls 122 extend and retract the cable between about 25 feet and about 50 feet. The controls 122 may be manually operated, such as by hand-crank, or may be remotely or electrically operated. Extending the cable 121 moves the radiation source 112 out of the exposure device 110 towards the collimator 150 and the work piece 101 to move the radiographic system 100 from the undeployed state, as shown in FIG. 1A, to the deployed state, as shown in FIG. 1B. Retracting the cable 121 moves the radiation source 112 towards the exposure device 110 and away from the collimator 150 and the work piece 101 to move the radiographic system 100 from the deployed state, as shown in FIG. 1B, to the undeployed state, as shown in FIG. 1A.

In one or more embodiments, the guide tube 140 is disposed between the collimator 150 and the exposure device 110 and guides the radiation source 112 from the exposure device 110 to the collimator 150 when the radiographic system 100 is being moved to the deployed state. The guide tube 140 also guides the radiation source 112 from the collimator 150 to the exposure device 110 when the radiographic system 100 is being moved to the undeployed state. In one or more embodiments, the collimator 150 may be directly coupled to the exposure device 110, such as by fittings or a threaded connection without the use of the guide tube 140.

The collimator 150 directs the radiation (e.g. one or more gamma rays) from the radiation source 112 toward the work piece 101 to image the work piece 101 when the radiographic system 100 is in the deployed state. The collimator 150 includes a housing 151, a radiation source bore 152, and the radiation port 153. When the radiographic system 100 is in the deployed state, the radiation source 112 is moved into the radiation source bore 152 of the collimator 150. In the deployed state, the radiation source 112 is substantially aligned with the radiation port 153 of the collimator 150. The radiation port 153 of the collimator 150 directs a cone of radiation 104 towards the work piece 101 to direct the radiation 102 to a desired imaging area 103. The housing 151 of the collimator 153 shields the environment from the radiation 102 emitted from the radiation source 112 to prevent and/or inhibit radiation 102 from being emitted in any direction other than the direction of the desired imaging area 103.

FIG. 1A illustrates the radiographic system 100 in the undeployed state. The radiographic system 100 is in the undeployed state when not being used to image a work piece, such as the work piece 101. For instance, the radiographic system 100 may be in the undeployed state when being stored or when in transport. In the undeployed state, the radiation source 112 is housed in the housing 111 of the exposure device 110 and is shielded by the housing 111 to minimize radiation exposure to the environment.

FIG. 1B illustrates the radiographic system 100 in the deployed state. The radiographic system 100 is in the deployed state when being used to image a work piece, such as the work piece 101.

According to one mode of operation, the radiographic system 100 is moved from the undeployed state to the deployed state by the controller 120. The controls 122 of the controller 120 are operated to extend the cable 121 to move the radiation source 112 from inside the housing 111 of the exposure device 110 to inside the radiation source bore 152 of the collimator 150. In embodiments including the guide tube 140, the radiation source 112 leaves the housing 111 of the exposure device 110 and is unshielded as it travels through the guide tube 140 to the radiation source bore 152 of the collimator 150. In embodiments not including the guide tube 140 where the exposure device 110 is directly coupled to the collimator 150, the radiation source 112 leaves the housing 111 of the exposure device 110 and directly enters the radiation source bore 152 of the collimator 150.

When the radiographic system 100 is in the deployed state, the radiation source 112 is disposed within the radiation source bore 152 of the collimator 150 and emits the radiation 102 through the radiation port 153 towards the work piece 101. The radiation port 153 directs the radiation 102 towards the desired imaging area 103 of the work piece 101 to image the desired imaging area 103 of the work piece 101.

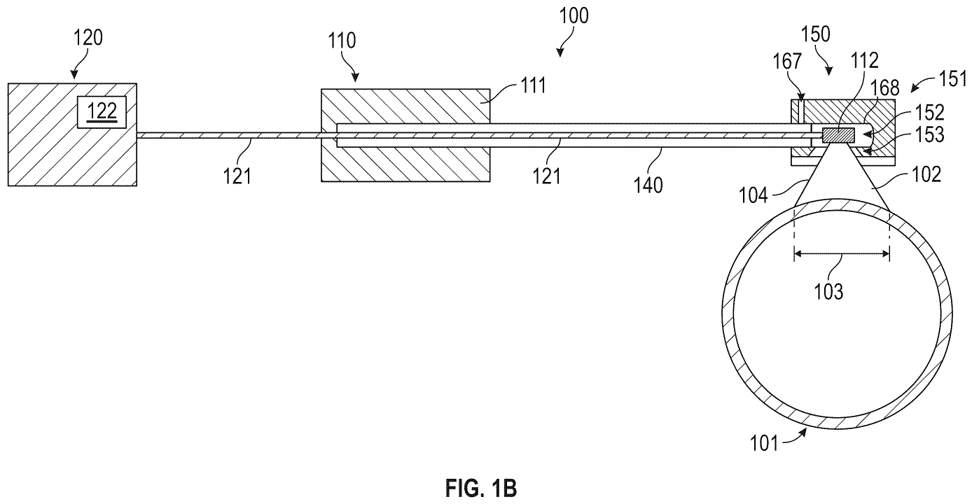

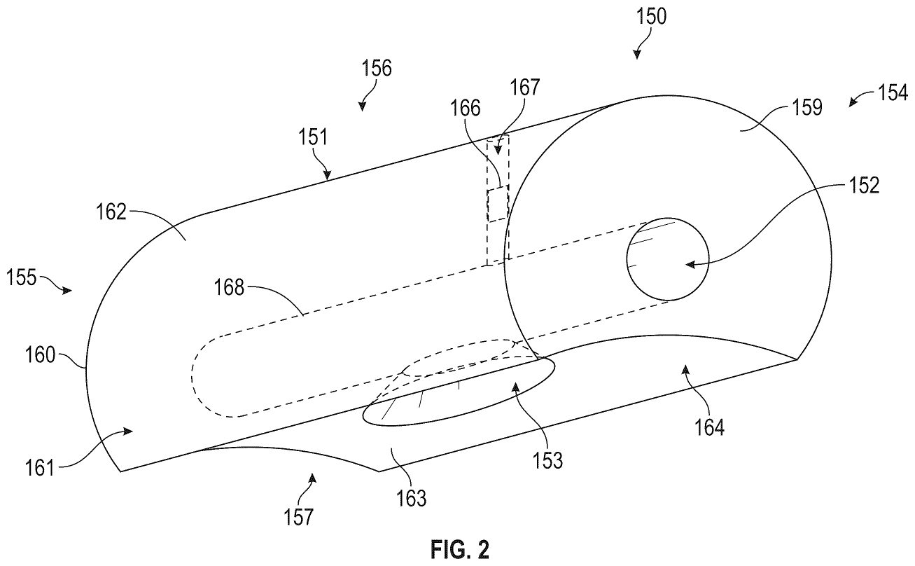

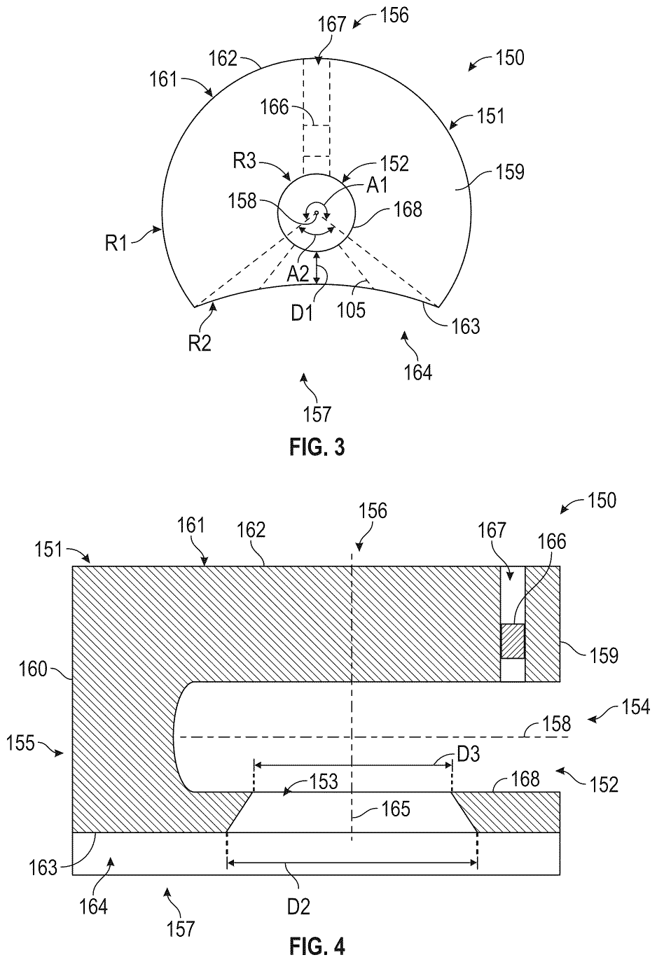

FIGS. 2-4 illustrate various views of the collimator 150 of the radiographic system 100. FIG. 2 illustrates an isometric view of the collimator 150. FIG. 3 illustrates a rear view of the collimator 150. FIG. 4 illustrates a side-cross-sectional view of the collimator 150.

The housing 151 of the collimator 150 may be made out of a metallic material, such as tungsten. The housing 151 of the collimator 150 has a first end 154, a second end 155, a top side 156, a bottom side 157, and a central axis 158. The bottom side 157 is the side of the housing 151 of the collimator 150 normal to and facing a desired imaging area (such as the desired imaging area 103 of FIGS. 1A-1B) of a work piece (such as the work piece 101 of FIGS. 1A-1B). The top side 156 of the housing 151 of the collimator 150 is the side opposite the bottom side 157.

The housing 151 of the collimator 150 is at least partially cylindrical. The housing 151 is at least partially axisymmetric about the central axis 158 such that a first end surface 159 at the first end 154 of the housing 151 is at least partially circular and a second end surface 160 at the second end 155 of the housing 155 is at least partially circular. Further, the housing 151 includes an outer surface 161 extending between the first end surface 159 and the second end surface 160. The outer surface 161 is perpendicular to the first end surface 159 and perpendicular to the second end surface 160. In one or more embodiments, the length of the collimator may be about 1.500 inches to about 2.500 inches.

The outer surface 161 includes a first outer surface portion 162 and a second outer surface portion 163. The first outer surface portion 162 is located generally on the top side 156 of the housing 151 and acts as a radiation shield, thereby preventing and/or inhibiting the radiation 102 from being emitted in a direction opposite from the work piece to be imaged. The first outer surface portion 162 is rounded with a radius of curvature R1. R1 may be about 1.500 inches to about 2.500 inches. In one or more embodiments, R1 may share a center point with the central axis 158 of the housing 151.

The second outer surface portion 163 has a concave surface 164 on the bottom side 157 of the housing 151. The concave surface 164 of the second outer surface portion 163 generally faces in the direction of the work piece. The second outer surface portion 163 is rounded with a radius of curvature R2. R2 may be about 1.250 inches to about 2.000 inches. The radius of curvature R2 may have a center point disposed below the central axis 158.

The first outer surface portion 162 and the second outer surface portion 163 combined form 100% of the outer surface 161. In one or more embodiments, the first outer surface portion 162 forms about 60% to about 75% (or to about 80%) of the outer surface 161. In one or more embodiments, the second outer surface portion 163 forms about 20% (or about 25%) to about 40% of the outer surface 161.

In one or more embodiments, the first outer surface portion 162 and second outer surface portion 163 may be defined by how much of the radiation source bore 152 each surrounds. In one or more embodiments, the first outer surface portion 162 surrounds a portion of the radiation source bore 152 that is defined by an angle A1 with an origin at the central axis 158 of the radiation source bore 152. Similarly, the second outer surface portion 163 surrounds a second portion of the radiation source bore 152 that is defined by an angle A2 with an origin at the central axis 158 of the radiation source bore. Because the radiation source bore 152 is surrounded on all sides, A1 and A2 sum to 360 degrees. In one or more embodiments, A1 is about 220 degrees to about 240 degrees, and A2 is about 120 degrees to about 140 degrees.

The radiation source bore 152 extends partially through the housing 151 of the collimator 150 from the first end surface 159. In one or more embodiments, the radiation source bore 152 may extend about 1.250 inches to about 1.500 inches from the first end surface 159. The radiation source bore 152 may have a radius R3 of about 0.474 inches to about 0.510 inches. The radiation source bore 152 is coaxial with the central axis 158 of the housing 151 and the center point of R1. An outer wall 168 of the radiation source bore 152 is a distance R1 minus R3 from the first outer surface portion 162. Because the distance from the outer wall 168 of the radiation source bore 152 to the first outer surface portion 162 is constant, the first outer surface portion 162 provides an equal amount of shielding for the span of the first outer surface portion 162.

The distance from the outer wall 168 of the radiation source bore 152 to the second outer surface portion 163 may vary due to the concave surface 164 of the second outer surface portion 163. A distance D1 is the minimum distance between the outer wall 168 of the radiation source bore 152 and the concave surface 164. In one or more embodiments, the distance D1 between the outer wall 168 of the radiation source bore 152 and the second outer surface portion 163 may be about 0.150 inches to about 0.200 inches.

The position of the radiation source bore 152 with respect to the first outer surface portion 162 and the second outer surface portion 163 allows an equal and maximum amount of radiation 102 to be shielded over a large area in the direction opposite from the work piece to be imaged. The position of the radiation source bore 152 with respect to the first outer surface portion 162 and the second outer surface portion 163 also ensures the radiation source 112 is close enough to the work piece and unshielded enough in the direction of the work piece to allow for accurate imaging.

The radiation port 153 is conical and extends from the outer wall 168 defining the radiation source bore 152 to and through the second outer surface portion 163. In one or more embodiments, a central axis 165 of the radiation port 153 is about 0.700 inches to about 0.950 inches from the first end surface 159. The radiation port 153 extends through the point in the second outer surface portion 163 where the distance between the radiation source bore 152 and the second outer surface portion 163 is at its minimum (e.g. at distance D1).

The central axis 165 of the radiation port 153 is transverse to the central axis 158 of the housing 151 and the radiation source bore 152. The central axis 165 of the radiation port 153 is aligned with the desired imaging area 103 of the work piece to be imaged. In one or more embodiments, the central axis 165 of the radiation port 153 is perpendicular to the central axis 158 of the housing 151 and the radiation source bore 152. The radiation port 153 may have a cone angle 105 of about 0 degrees (or about 55 degrees) to about 70 degrees. The conical shape and the cone angle 105 of the radiation port 153 forms the shape of the radiation 102 directed at the work piece. If the radiation port 153 has a wider cone angle, the desired imaging area will be larger than if the radiation port 153 has a narrower cone angle. In one or more embodiments, a diameter D2 of the radiation port 153 at the second outer surface portion 163 is about 0.500 inches (or about 0.700 inches) to about 1.000 inches. In one or more embodiments, a diameter D3 of the radiation port 153 at the outer wall 168 of the radiation source bore 152 is about 0.500 inches to about 0.750 inches (or to about 1.000 inches).

In one or more embodiments, the collimator 150 further includes a set screw 166 disposed in a hole 167 formed through the outer surface 161 to the radiation source bore 152. The set screw 166 is may be threaded into the hole 167 and into the radiation source bore 152 to clamp the collimator 150 onto the guide tube 140 or to the exposure device 110 from which the radiation source 112 extends.

Any one or more components of the radiographic system 100 may be integrally formed together, directly coupled together, and/or indirectly coupled together and are not limited to the specific arrangement of components illustrated in FIGS. 1A-4. Any one or more of the embodiments of the radiographic system 100 may be combined in whole or part with any one or more of the embodiments of the radiographic system 100.

While the present disclosure has been described with respect to a number of embodiments and examples, those skilled in the art, having benefit of this disclosure, will appreciate that other embodiments can be devised which do not depart from the scope and spirit of the present disclosure.

It will be appreciated by those skilled in the art that the preceding embodiments are exemplary and not limiting. It is intended that all modifications, permutations, enhancements, equivalents, and improvements thereto that are apparent to those skilled in the art upon a reading of the specification and a study of the drawings are included within the scope of the disclosure. It is therefore intended that the following appended claims may include all such modifications, permutations, enhancements, equivalents, and improvements. The disclosure also contemplates that one or more aspects of the embodiments described herein may be substituted in for one or more of the other aspects described. The scope of the disclosure is determined by the claims that follow.

What is claimed is:

1. A collimator, comprising:
an outer surface, wherein the outer surface comprises a first outer surface portion and a second outer surface portion, and wherein the second outer surface portion has a concave surface;
a radiation source bore; and
a radiation port extending from an outer wall of the radiation source bore to the second outer surface portion.

2. The collimator of claim 1, wherein the first outer surface portion includes a first radius of curvature and the second outer surface portion includes a second radius of curvature different from the first radius of curvature.

3. The collimator of claim 2, wherein the first radius of curvature is greater than the second radius of curvature.

4. The collimator of claim 2, wherein the radiation source bore is coaxial with a center point of the first radius of curvature.

5. The collimator of claim 1, wherein the first outer surface portion is about 70% to about 80% of the outer surface.

6. The collimator of claim 1, wherein the second outer surface portion is about 20% to about 30% of the outer surface.

7. The collimator of claim 1, wherein the radiation port is conical, wherein a first diameter of the radiation port at the second outer surface portion is about 0.500 inches to about 1.000 inches, and wherein a second diameter of the radiation port at the outer wall of the radiation source bore is about 0.500 inches to about 1.000 inches.

8. The collimator of claim 1, wherein the first outer surface portion surrounds a first portion of the radiation source bore, wherein the first portion is defined by a first angle, and wherein the first angle is about 220 degrees to about 240 degrees.

9. The collimator of claim 1, wherein the second outer surface portion surrounds a second portion of the radiation source bore, wherein the second portion is defined by a second angle, and wherein the second angle is about 120 degrees to about 140 degrees.

10. The collimator of claim 1, wherein of the outer wall of the radiation source bore is at least about 0.150 inches to about 0.200 inches from the second outer surface portion.

11. A radiographic system, comprising:
an exposure device;
a controller having a cable that extends into the exposure device;
a radiation source located in the exposure device and coupled to one end of the cable; and
a collimator coupled to the exposure device, wherein the controller extends and retracts the cable to move the radiation source between the exposure device and the collimator;
wherein the collimator comprises:
an outer surface, wherein the outer surface comprises a first outer surface portion including a first radius of curvature and a second outer surface portion including a second radius of curvature, wherein the first radius of curvature is different from the second radius of curvature;
a radiation source bore including an outer wall; and
a radiation port extending from the second outer surface portion to the outer wall of the radiation source bore.

12. The radiographic system of claim 11, further comprising a guide tube coupled to the exposure device and the collimator, wherein the controller extends and retracts the cable to move the radiation source through the guide tube between the exposure device and the collimator.

13. The radiographic system of claim 11, wherein the second outer surface portion includes a concave surface.

14. The radiographic system of claim 11, wherein the first radius of curvature includes a center, wherein the center of the first radius of curvature is coaxial with the radiation source bore, and wherein the first radius of curvature is greater than the second radius of curvature.

15. The radiographic system of claim 11, wherein the first outer surface portion is about 70% to about 80% of the outer surface.

16. The radiographic system of claim 11, wherein the second outer surface portion is about 20% to about 30% of the outer surface.

17. The radiographic system of claim 11, wherein the radiation port is conical, wherein a first diameter of the radiation port at the second outer surface portion is about 0.500 inches to about 1.000 inches, and wherein a second diameter of the radiation port at the outer wall of the radiation source bore is about 0.500 inches to about 1.000 inches.

18. The radiographic system of claim 11, wherein the first outer surface portion surrounds a first portion of the radiation source bore, wherein the first portion is defined by a first angle, and wherein the first angle is about 220 degrees to about 240 degrees.

19. The radiographic system of claim 11, wherein the second outer surface portion surrounds a second portion of the radiation source bore, wherein the second portion is defined by a second angle, and wherein the second angle is about 120 degrees to about 140 degrees.

20. The radiographic system of claim 11, wherein the outer wall of the radiation source bore is at least about 0.150 inches to about 0.200 inches from the second outer surface portion.
